(19) United States
(12) Patent Application Publication
(10) Pub. No.: US 2006/0097969 A1
(43) Pub. Date: May 11, 2006

(54) Data driving system and display having adjustable common voltage

(75) Inventors: Yao-Jen Tsai, Hsinhua (TW); Yung-Yuan Ho, Hsinhua (TW)

Correspondence Address: LADAS & PARRY, 26 WEST 61ST STREET, NEW YORK, NY, 10023, US

(73) Assignee: HIMAX TECHNOLOGIES, INC.

(21) Appl. No.: 11/265,426

(22) Filed: Nov. 2, 2005

(30) Foreign Application Priority Data
Nov. 10, 2004 (TW) 093134348

(51) Int. Cl. G09G 3/36

(52) U.S. Cl. 345/88

(57) ABSTRACT

The invention relates to a data driving system and a display, wherein the data driving system for driving a display panel, comprises a Gamma reference voltage generator, a common voltage generator, and a plurality of data drivers. The Gamma reference voltage generator is used for generating a plurality of Gamma reference voltages. The common voltage generator is used for dynamically generating a common voltage according to a first control signal. The data drivers are used for receiving the Gamma reference voltages and the common voltage to generate corresponding display signals to the display panel. Therefore, the data driving system of the present invention can dynamically adjust the common voltage to match with the change of the liquid crystal characteristic of the liquid crystal display. Besides, the Gamma reference voltages are dynamically adjusted to match with the common voltage, so as to completely resolve the interference in the liquid crystal characteristic of the liquid crystal display due to the changing in temperature and used time. Therefore, the liquid crystal display of the present invention can show the best image in any used time and any circumstance.

### BACKGROUND OF THE INVENTION

1. Field of the Invention

The present invention relates to a display, and more particularly to a data driving system.

2. Description of the Related Art

Referring to FIG. 1, a conventional display 10 comprises a display panel 11, a plurality of data drivers 12, a plurality of gate drivers 13, a programmable Gamma reference voltage generator 16, and a timing controller 17. The display panel 11 (taking the liquid crystal display panel as an example) comprises a plurality of pixels disposed at the cross points of a plurality of transverse gate lines and a plurality of longitudinal data lines.

The gate drivers 13 sequentially transfer scan signals to the gate lines. The data drivers 12 are used for transferring display signals to the display panel 11 for displaying images. The programmable Gamma reference voltage generator 16 is used for receiving control signals from the timing controller 17, to dynamically adjust the Gamma reference voltages, which are transferred to the data drivers 12. Referring to FIG. 2, due to the liquid crystal characteristics of the liquid crystal display, the voltage-transmittance curve of the Nth frame 21 may be different from that of the (N+1)th frame 22, such that the differences in the liquid crystal characteristics may be compensated partially by dynamically adjusting the Gamma reference voltages to achieve a more proper transmittance.

However, in the conventional display 10, the common voltage (Vcom) thereof is supplied with a desired voltage by a DC voltage (Vdc), thus the Vcom is maintained at a DC level, which cannot be dynamically adjusted as the above-mentioned Gamma reference voltages. Therefore, as for such a conventional display 10, only the dynamical adjustment in Gamma reference voltages cannot completely resolve the interference in the liquid crystal characteristic of the liquid crystal display due to the changing in temperature and used time.

Accordingly, it is desired to provide a novel and creative data driving system to overcome the above-mentioned problems.

### SUMMARY OF THE INVENTION

The object of the present invention is to provide a data driving system and a display, wherein the data driving system is used for driving a display panel. The data driving system comprises a Gamma reference voltage generator, a common voltage generator, and a plurality of data drivers. The Gamma reference voltage generator is used for generating a plurality of Gamma reference voltages. The common voltage generator is used for dynamically generating a common voltage according to a first control signal. The data drivers are used for receiving the Gamma reference voltages and the common voltage to generate corresponding display signals to the display panel.

Therefore, the data driving system of the present invention can dynamically adjust the common voltage to match with the change in the liquid crystal characteristic of the liquid crystal display. Besides, the Gamma reference voltages are dynamically adjusted to match with the common voltage, so as to completely resolve the interference in the liquid crystal characteristic of the liquid crystal display due to the changing in temperature and used time. Therefore, the liquid crystal display of the present invention can show the best image in any used time and any circumstance.

### BRIEF DESCRIPTION OF THE DRAWINGS

FIG. 1 is a schematic view of a conventional display;

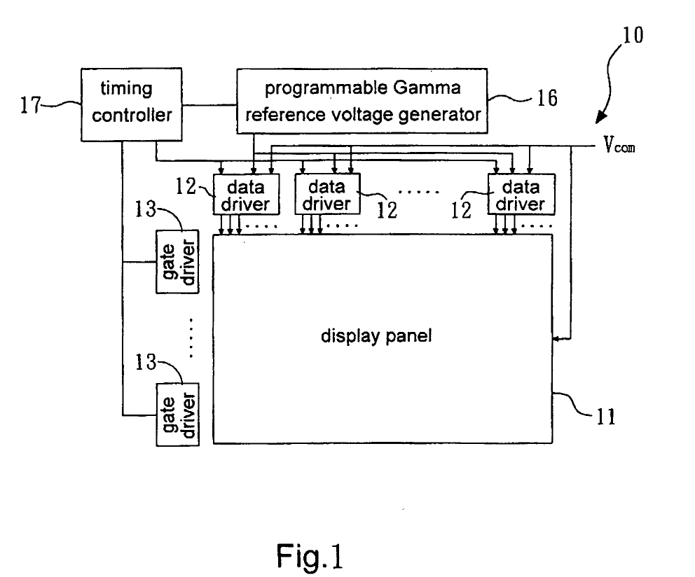

FIG. 2 is a schematic view of voltage-transmittance curves of the conventional liquid crystal characteristics;

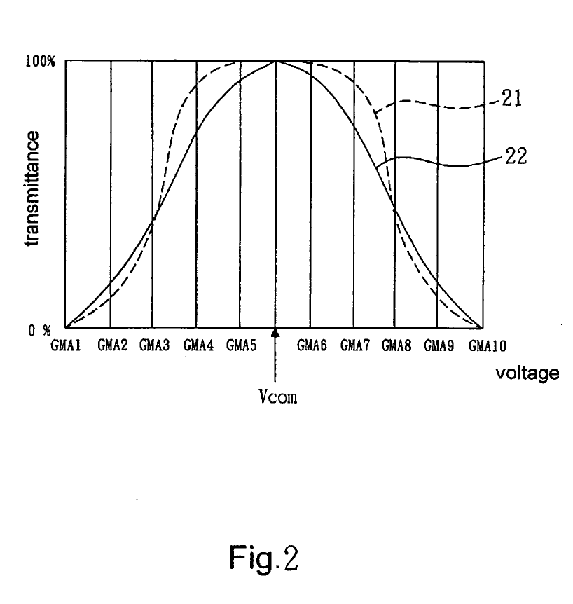

FIG. 3 is a schematic view of a display of the present invention;

FIG. 4 is a schematic view of a programmable voltage generator of the present invention; and

FIG. 5 is a schematic view of voltage-transmittance curves of the adjustable common voltage of the present invention.

### DETAILED DESCRIPTION OF THE INVENTION

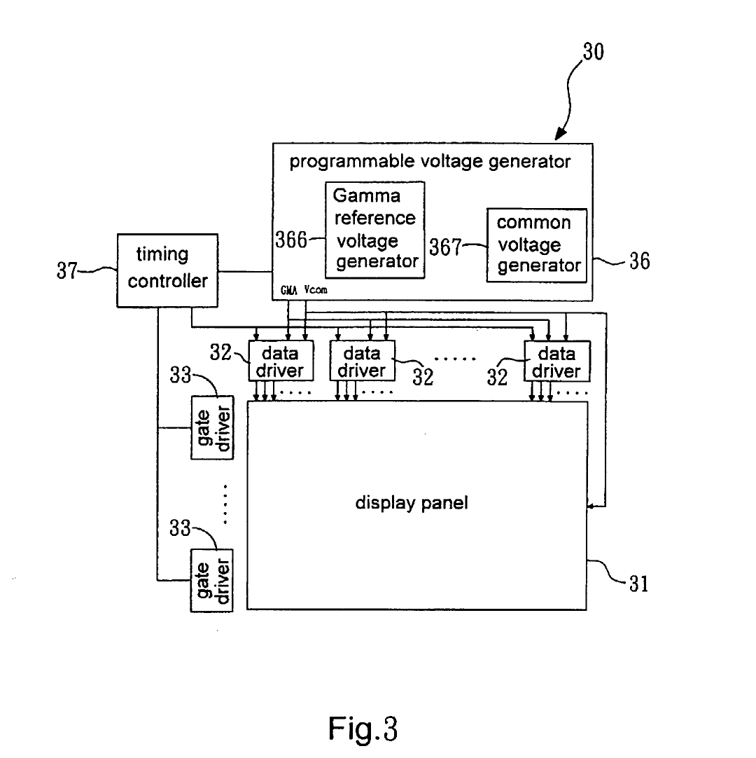

Referring to FIG. 3, it is a schematic view of a display 30 of the present invention. The display 30 of the present invention comprises a display panel 31, a plurality of data drivers 32, a plurality of gate drivers 33, a programmable voltage generator 36 and a timing controller 37. The data drivers 32, the programmable voltage generator 36 and the timing controller 37 can be combined into a data driving system for driving the display panel 31, and providing display signals to the display panel 31.

The programmable voltage generator 36 comprises a Gamma reference voltage generator 366 and a common voltage generator 367. The Gamma reference voltage generator 366 is used for generating a plurality of Gamma reference voltages (GMA). Preferably, the Gamma reference voltage generator 366 dynamically adjusts the GMAs, which are transferred to the data drivers 32, according to the control signal of the timing controller 37.

The common voltage generator 367 dynamically generates a common voltage (Vcom) according to the control signal of the timing controller 37. The timing controller 37 can be a conventional timing controller, but it can further receive at least one input signal to generate corresponding control signals to the Gamma reference voltage generator 366 and the common voltage generator 367.

The input signal can be a temperature-sensing signal for sensing the temperature of the display. Since the liquid crystal characteristic of the liquid crystal display is more sensitive to the temperature, and particularly the rising temperature readily results in the offsets of the Vcom and the GMAs, flicker and images with poor quality are likely to occur. Therefore, according to the temperature-sensing signal, the timing controller 37 generates corresponding control signals to the Gamma reference voltage generator 366 and the common voltage generator 367, e.g., a first control signal to the common voltage generator 367, and a second one to the Gamma reference voltage generator 366. Therefore, the Vcom and these GMAs may be dynamically adjusted according to the changing of temperature so as to eliminate the adverse effects of the offsets of the Vcom or the GMAs caused by the changing of temperature.

The input signal can be a counter signal for counting the used time of the display. Since the liquid crystal characteristic may vary with the used time, the used time of the display is recorded according to the counter signal such that the timing controller 37 generates corresponding control signals to the Gamma reference voltage generator 366 and the common voltage generator 367. Then the Vcom and the GMAs may be dynamically adjusted depending on a different used time, thereby eliminating the differences of the liquid crystal characteristics caused by the different used time and the adverse effects of the offsets of the Vcom or the GMAs.

The timing controller 37 in the above embodiments of the present invention is not necessarily limited to be a conventional timing controller additionally receiving a temperature-sensing signal or a counter signal. It may also be a controller, or a microprocessor, which is mainly used for receiving at least one input signal to generate corresponding control signals to the Gamma reference voltage generator 366 and the common voltage generator 367.

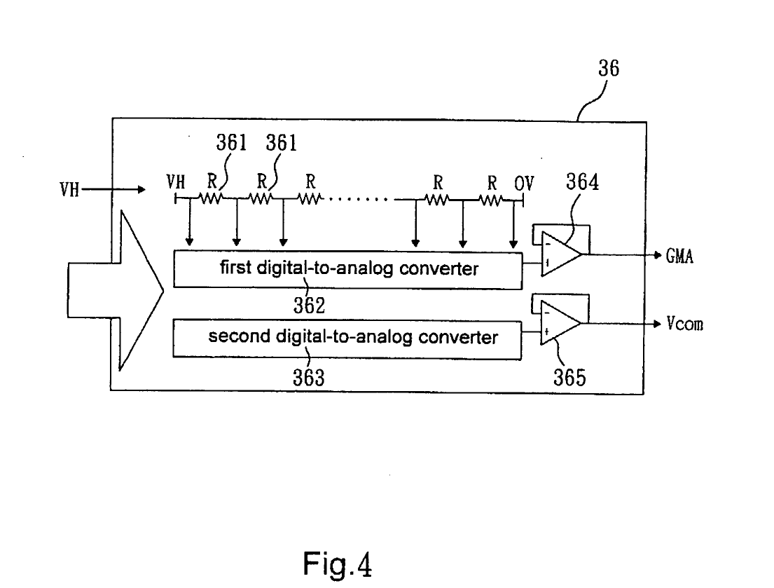

Referring to FIG. 4, it is a schematic view of the elements of a programmable voltage generator 36 of the present invention. The programmable voltage generator 36 comprises a plurality of voltage-dividing resistors 361, at least one first digital-to-analog converter 362, a second digital-to-analog converter 363, and operational amplifiers 364, 365, etc., which facilitate the Gamma reference voltage generator 366 to be integrated with the common voltage generator 367, such that the programmable voltage generator 36 may dynamically generate the GMAs and Vcom according to the control signals.

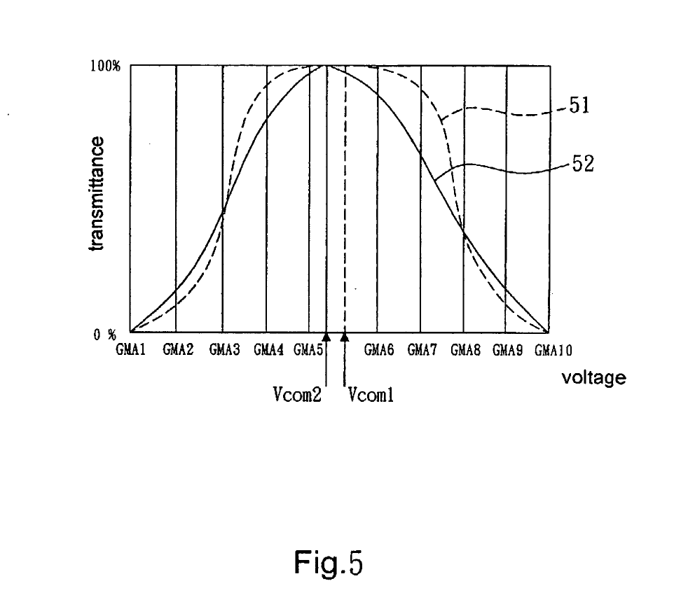

Referring to FIG. 5, the voltage-transmittance curve of the Nth frame 51 is different from that of the (N+1)th frame 52, thus the data driving system and the display of the present invention are utilized to dynamically adjust the Vcom and the GMAs in order to achieve a proper transmittance and to eliminate the adverse effects caused by the differences between the voltage-transmittance curves. Particularly, the data driving system and the display of the present invention can dynamically adjust the Vcom, e.g., adjusting the first common voltage (Vcom1) of FIG. 5 into the second common voltage (Vcom2) in combination with dynamically adjusting the GMAs so as to completely resolve the interference in the liquid crystal characteristic of the liquid crystal display due to the changing in temperature and used time. Therefore, the liquid crystal display of the present invention can show the best image in any used time and any circumstance.

While an embodiment of the present invention has been illustrated and described, various modifications and improvements can be made by those skilled in the art. The embodiment of the present invention is therefore described in an illustrative, but not restrictive, sense. It is intended that the present invention may not be limited to the particular forms as illustrated, and that all modifications which maintain the spirit and scope of the present invention are within the scope as defined in the appended claims.

What is claimed is:

1. A data driving system for driving a display panel, comprising:
a Gamma reference voltage generator, for generating a plurality of Gamma reference voltages;
a common voltage generator, for dynamically generating a common voltage according to a first control signal; and
a plurality of data drivers, for receiving the Gamma reference voltages and the common voltage to generate corresponding display signals to the display panel.

2. The data driving system according to claim 1, further comprising a controller for receiving at least one input signal and generating the first control signal to the common voltage generator.

3. The data driving system according to claim 2, wherein the input signal is a temperature-sensing signal.

4. The data driving system according to claim 2, wherein the input signal is a counter signal.

5. The data driving system according to claim 2, wherein the controller is a timing controller.

6. The data driving system according to claim 2, wherein the controller is a microprocessor.

7. The data driving system according to claim 1, wherein the Gamma reference voltage generator is used for dynamically generating a plurality of Gamma reference voltages according to a second control signal.

8. The data driving system according to claim 7, further comprising a controller for receiving at least one input signal and generating the second control signal to the Gamma reference voltage generator.

9. The data driving system according to claim 8, wherein the input signal is a temperature-sensing signal.

10. The data driving system according to claim 8, wherein the input signal is a counter signal.

11. The data driving system according to claim 8, wherein the controller is a timing controller.

12. The data driving system according to claim 8, wherein the controller is a microprocessor.

13. The data driving system according to claim 1, wherein the Gamma reference voltage generator and the common voltage generator are combined into a programmable voltage generator.

14. A display comprising:
a display panel;
a plurality of gate drivers, for scanning and controlling the display panel;
a Gamma reference voltage generator, for generating a plurality of Gamma reference voltages;
a common voltage generator, for dynamically generating a common voltage according to a first control signal; and
a plurality of data drivers, for receiving the Gamma reference voltages and the common voltage to generate corresponding display signals to the display panel.

15. The display according to claim 14, further comprising a controller for receiving at least one input signal and generating the first control signal to the common voltage generator.

16. The display according to claim 15, wherein the input signal is a temperature-sensing signal.

17. The display according to claim 15, wherein the input signal is a counter signal.

18. The display according to claim 15, wherein the controller is a timing controller.

19. The display according to claim 15, wherein the controller is a microprocessor.

20. The display according to claim 14, wherein the Gamma reference voltage generator is used for dynamically generating a plurality of Gamma reference voltages according to a second control signal.

21. The display according to claim 20, further comprising a controller for receiving at least one input signal and generating a second corresponding control signal to the Gamma reference voltage generator.

22. The display according to claim 21, wherein the input signal is a temperature-sensing signal.

23. The display according to claim 21, wherein the input signal is a counter signal.

24. The display according to claim 21, wherein the controller is a timing controller.

25. The display according to claim 21, wherein the controller is a microprocessor.

26. The display according to claim 14, wherein the Gamma reference voltage generator and the common voltage signal level generator are combined into a programmable voltage generator.
